(19) United States
(12) Patent Application Publication
(10) Pub. No.: US 2026/0150092 A1
(43) Pub. Date: May 28, 2026

(54) OPTIMIZED RESOURCE ALLOCATION AND MANAGEMENT OF SHARED RADIO INFRASTRUCTURE FOR MULTI-OPERATOR RADIO ACCESS NETWORK (RAN) SYSTEM

(71) Applicant: ANI Acquisition Sub, LLC, Boca Raton, FL (US)

(72) Inventors: Kalle Ahmavaara, Corning, NY (US); Deepak Pengoria, San Jose, CA (US)

(73) Assignee: ANI Acquisition Sub, LLC, Boca Raton, FL (US)

(21) Appl. No.: 19/397,681

(22) Filed: Nov. 21, 2025

Related U.S. Application Data
(60) Provisional application No. 63/725,649, filed on Nov. 27, 2024.

(51) Int. Cl. H04W 72/0453

(52) U.S. Cl. CPC H04W 72/0453

(57) ABSTRACT

Optimization of resource allocation and management of shared radio infrastructure for a multi-operator radio access network (RAN) system. The RAN system includes multiple RANs that each provide a base station to provide a cell for a respective operator and shared radio nodes that service signals for one or more cells of its coupled RAN(s). The RAN system is configured for RUs to be shared between the multiple RANs. To provide for the flexibility of the RAN system to support multiple RANs but with shared remote units (RUs), the radio infrastructure includes shared radio resources. To avoid shared radio resource conflicts that may occur by the multiple RANs accessing a shared radio resource beyond its finite capability, the radio infrastructure is configured to selectively allocate the shared radio resources to the multiple RANs based on a radio resource configuration.

### CROSS-REFERENCE TO RELATED APPLICATIONS

This application claims the benefit of priority under 35 U.S.C. § 119(e) of U.S. Provisional Application No. 63/725,649, filed Nov. 27, 2024, the contents of which are incorporated herein by reference in its entirety.

### BACKGROUND

This disclosure relates generally to wireless communications systems (WCSs) and related networks, such as Universal Mobile Telecommunications Systems (UMTSs), its offspring Long Term Evolution (LTE) and 5^{th} Generation New Radio (5G-NR) described and being developed by the Third Generation Partnership Project (3GPP), and more particularly to radio access networks (RANs) and user mobile communication devices connecting thereto, including small cell RANs and Open-RANs (O-RANs), implemented in such mobile communications systems.

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communications systems have been provided to transmit and/or distribute communication signals to wireless devices called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of a radio node/base station that transmits communication signals distributed over physical communications medium remote unit forming radio frequency (RF) antenna coverage areas, also referred to as “antenna coverage areas.” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communications system includes radio nodes, such as base stations, that form cell radio access networks, wherein the radio nodes are configured to transmit communication signals wirelessly directly to client devices without being distributed through intermediate remote units.

Operators of mobile systems, such as UMTSs and its offspring, including LTE and LTE-Advanced, are increasingly relying on wireless small cell RANs in order to deploy for example indoor voice and data services to enterprises and other customers. Such small cell RANs typically utilize multiple-access technologies capable of supporting communications with multiple users using RF signals and sharing available system resources such as bandwidth and transmit power. Evolved universal terrestrial radio access (E-UTRA) is the radio interface of 3GPP's LTE upgrade path for UMTS mobile networks. In these systems, there are different frequencies where LTE (or E-UTRA) can be used, and in such systems, user mobile communications devices connect to a serving system, which is represented by a cell. In LTE, each cell is produced by a node called eNodeB (eNB). A gNodeB (gNB) is a node in a cellular network that provides connectivity between user equipment (UE) and the evolved packet core (EPC).

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(D). For example, the radio node 102 may be a base station that includes modem functionality and is configured to distribute communication signal streams 108(1)-108(S) to the wireless client devices 106(1)-106(W) based on communication signals 110(1)-110(N) received from the service providers 104(1)-104(N). The communication signal streams 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the communication signal streams 108(1)-108(S) for the multiple service providers 104(1)-104(N) based on respective communication signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the communication signal streams 108(1)-108(S) to serve multiple wireless client devices 106(1)-106(W). For example, the multiple RF beams 120(1)-120(N) may support multiple-input, multiple-output (MIMO) communications.

The WCS 100 may be configured to operate as a 5G and/or a 5G-NR communications system. In this regard, the radio node 102 can function as a 5G or 5G-NR base station (a.k.a. gNodeB) to service the wireless client devices 106(1)-106(W). Notably, the 5G or 5G-NR wireless communications system may be implemented based on a millimeter-wave (mmWave) spectrum that can make the communication signals 110(1)-110(N) more susceptible to propagation loss and/or interference. As such, it is desirable to radiate the RF beams 120(1)-120(N) via RF beamforming to help mitigate signal propagation loss and/or interference. The WCS 100 is capable to accommodate a vast range of frequency spectrums, including the higher-frequency ranges utilized by 5G, such as the C-Band.

The WCS 100 may be further configured to operate based on an Open-RAN (O-RAN) architecture. O-RAN is a standard set forth by the O-RAN Alliance, found at https://www.o-ran.org/. The O-RAN standard specifies multiple options for functional divisions of a cellular base station between physical units and it also specifies the interface between these units. FIGS. 2A and 2B are schematic diagrams providing exemplary illustration of O-RANs 200 and 202, respectively, that are configured according to O-RAN shared-cell topology.

In the O-RANs 200, 202, the functionality of the base station (e.g., gNB, as called in the context of 5G) is divided into three functional units of an O-RAN central unit (O-CU) 204, an O-RAN distribution unit (O-DU) 206, and one or more O-RAN remote units (O-RUs) 208(1)-208(N). The ORUs 208(1)-208(N) can either be a single radio unit as shown in 208(1)-208(N) or a complete distribution system. These components may run on different hardware platforms and reside at different locations. The O-RUs 208(1)-208(N) include the lowest layers of the base station, and it is the entity that wirelessly transmits and receives signals to user devices. The O-CU 204 includes the highest layers of the base station and is coupled to a “core network” of the cellular service provider. The O-DU 206 includes the middle layers of the base station to provide support for a single cellular service provider (also known as operator or carrier). An F1 interface 210 is connected between the O-CU 204 and the O-DU 206. An eCPRI/O-RAN fronthaul interface 212 connects the O-DU 206 and an O-RUs 208. The F1 interface 210 and eCPRI/O-RAN fronthaul interface 212 use Ethernet protocol for conveying the data in this example. Therefore, Ethernet switches (not shown in FIGS. 2A and 2B) may exist between the O-CU 204 and the O-DU 206, and between the O-DU 206 and the O-RU 208.

Each O-DU 206 can also be coupled to a single or to a cluster of O-RUs 208(1)-208(N) that serve signals of the one or more “cells” of the O-DU 206. A “cell” in this context is a set of signals intended to serve subscriber units (e.g., cellular devices) in a certain area. Multiple O-RUs 208(1)-208(N) are supported in the O-RAN by what is referred to as “Shared-Cell.” Shared Cell is realized by a front-haul multiplexer (FHM) 214, placed between the O-DU 206 and the O-RUs 208(1)-208(N). The FHM 214 de-multiplexes downlink signals from the O-DU 206 to the plurality of O-RUs 208(1)-208(N), and multiplexes uplink signals from the plurality of O-RUs 208(1)-208(N) to the O-DU 206. The FHM 214 can be considered as an O-RU with fronthaul support and additional copy-and-combine function, but lacks the RF front end capability. The O-RAN 200 in FIG. 2A shows the O-RUs 208(1)-208(N) supporting the same cell (#1). The O-RAN 202 in FIG. 2B shows each O-RU 208(1)-208(N) supporting the different cell (#1 . . . #M). In each case of the O-RANs 200, 202 in FIGS. 2A and 2B, and the O-DU 206 provide support for a single cellular service provider to provide cell services to the plurality of O-RUs 208(1)-208(N).

No admission is made that any reference cited herein constitutes prior art. Applicant expressly reserves the right to challenge the accuracy and pertinency of any cited documents.

### SUMMARY

Embodiments disclosed herein optimized resource allocation and management of shared radio infrastructure for a multi-operator radio access network (RAN) system. For example, the RAN system may be an Open-RAN (O-RAN) system that includes one or more RANs that are compatible with the Open RAN standard set forth by the O-RAN Alliance and referred to herein as an “O-RAN system.” In exemplary embodiments, the RAN system includes multiple RANs that each provide a base station to provide a cell for a respective operator (e.g., a macrocell, small cell), which includes a set of signals intended to serve subscriber units (e.g., cellular devices) in a certain coverage area. The RANs are configured to be coupled to a respective “core network” of the cellular service provider (also known as operator or carrier). Each RAN also includes one or more radio nodes, also referred to as radio unit (RUs), that wirelessly transmits and receives signals to user devices. The RAN system can be configured for the multiple RANs to be able to share the RUs such that the RUs are capable of servicing signals for more than one cell of its coupled RAN(s). A benefit of multiple RANs sharing a RU is that the shared RU can serve the multiple service providers of the RAN(s) each employing their own separate base station functionality.

In exemplary aspects, the RAN system includes a radio infrastructure communicated coupled to the multiple RANs through a wired (e.g. eCPRI/O-RAN fronthaul interface) or wireless (RF) interface. The radio infrastructure may be a network hub for example. The radio infrastructure is configured to aggregate the downlink communication signals from the multiple RANs to be communicated by the shared RUs to user devices. In this manner, the radio infrastructure allows the RUs to be shared among the multiple RANs to serve multiple cells for multiple operators. The radio infrastructure is also configured to receive uplink communication signals from the RUs for the multiple cells and distribute the uplink communication signals to the appropriate RAN configured to support the operator cell of the uplink communication signals. To provide for the flexibility of the RAN system to support multiple RANs but with shared RUs, the radio infrastructure includes shared radio resources. However, these shared radio resources are finite resources. Thus, to avoid radio resource conflicts that may occur by the multiple RANs accessing a shared radio resource beyond its finite capability, in exemplary aspects, the radio infrastructure is configured to selectively allocate the shared radio resources to the multiple RANs based on a radio resource configuration. The radio resource configuration can be provided by one of the RANs in the RAN system to the radio infrastructure to be used to allocate the shared radio resources to the RANs or from a source outside of the RAN system. In this manner, a capability of a given shared radio resource is not accessible to multiple RANs in a manner that could result in a radio resource conflict due to concurrent access by the multiple RANs exceeding the maximum capability of such given shared radio resource.

As discussed above, the radio infrastructure includes shared radio resources that can be selected allocated to the multiple RANs. As an example, the radio infrastructure can include multiple signal inputs (e.g., baseband inputs and/or RF inputs) as a shared radio resource that can be selective allocated to different RANs to provide connectivity between the RANs and the radio infrastructure. In another example, the radio infrastructure can also include multiple antenna ports that are associated with RF circuit chains that each include one or more power amplifiers as a share resource for interfacing and processing communication signals with RUs that can be selectively allocated to the RANs. In another example, the radio infrastructure can support multiple frequency bands (that have a specific downlink and uplink frequency range) as a shared resource which can be selectively allocated to the multiple RANs. In another example, the radio infrastructure can support a downlink frequency within the supported frequency band(s), uplink frequency within the supported frequency band(s), downlink bandwidth, uplink bandwidth, and/or power sharing between the supported frequency bands that can be selectively allocated and split between the multiple RANs so that the maximum bandwidth for a particular frequency band is not exceeded by the RANs. In another example, the radio infrastructure can support as a shared resource, on a per RAN basis, an allocation of the total power available to each RAN for the frequency bands configured to be supported by the RAN.

One exemplary embodiment of the disclosure relates to a radio infrastructure for a multi-operator RAN system. The radio infrastructure includes shared radio resources configured to be utilized to distribute communication signals and a controller. The controller is configured to: control distribution of communication signals between the plurality of RANs and the plurality of RUs based on radio resource information in a radio resource configuration indicating an allocation of shared radio resources to each of the plurality of RANs, receive a plurality of RAN radio resource sharing requests, each comprising RAN shared resource information for each of the plurality of RANs, and configure the radio resource information in the radio resource configuration based on the RAN shared resource information in the plurality of RAN radio resource sharing requests to allocate the shared radio resources to the plurality of RANs.

An additional exemplary embodiment of the disclosure relates to a method of shared radio resource allocation in a radio infrastructure supporting multiple RANs in a RAN system. The method includes controlling distribution of communication signals between a plurality of RANs and a plurality of RUs based on radio resource information in a radio resource configuration indicating an allocation of shared radio resources to each of the plurality of RANs, receiving a plurality of RAN radio resource sharing requests each comprising RAN shared resource information for each of the plurality of RANs, and configuring the radio resource information in the radio resource configuration based on the RAN shared resource information in the plurality of RAN radio resource sharing requests to allocate the shared radio resources to the plurality of RANs.

An additional exemplary embodiment of the disclosure relates to a multi-operator RAN system. The multi-operator RAN system includes a plurality of radio access networks (RANs), a plurality of remote units (RUs) and a radio infrastructure configured to be communicatively coupled to a plurality of remote units (RUs) and a plurality of radio access networks (RANs). The radio infrastructure comprising: shared radio resources configured to be utilized to distribute communication signals; and a controller configured to control distribution of communication signals between the plurality of RANs and the plurality of RUs based on radio resource information in a radio resource configuration indicating an allocation of shared radio resources to each of the plurality of RANs, receive a plurality of RAN radio resource sharing requests each comprising RAN shared resource information for each of the plurality of RANs; and configure the radio resource information in the radio resource configuration based on the RAN shared resource information in the plurality of RAN radio resource sharing requests to allocate the shared radio resources to the plurality of RANs.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more embodiments and together with the description serve to explain principles and operation of the various embodiments.

### BRIEF DESCRIPTION OF THE DRAWINGS

FIG. 1 is a schematic diagram of an exemplary Radio Access Network (RAN) that includes a conventional single operator radio node that includes a massive antenna array (MAA) to support distribution of communication signals to a user devices;

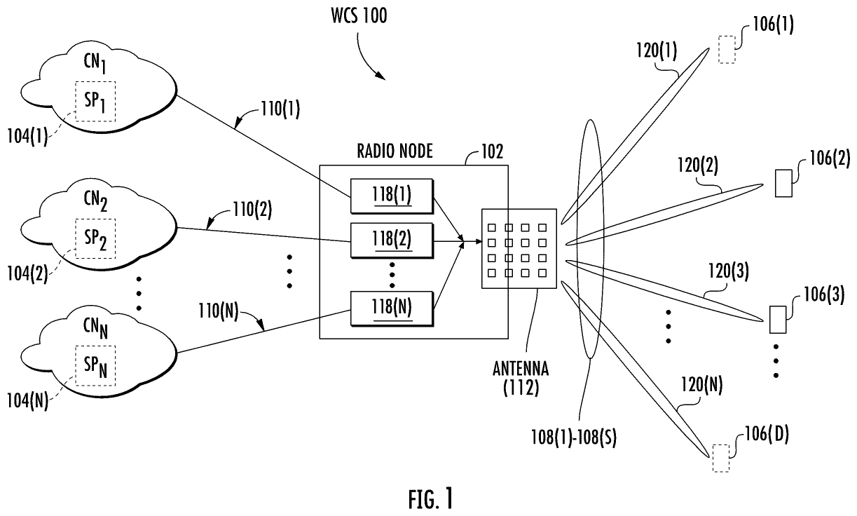

FIGS. 2A and 2B are examples of Open-standard RANs (O-RANs);

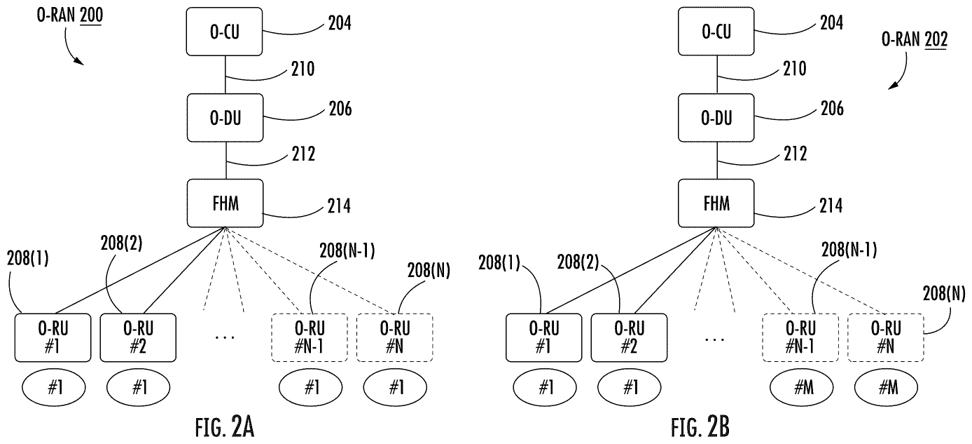

FIG. 3 is an exemplary RAN system that includes multiple O-RANs that are configured to support different service providers and that are each configured to directly interface with a shared modified Open-standard remote unit (O-RU);

FIG. 4 is an exemplary multi-operator RAN system that includes multiple RANs (e.g., O-RANs) implemented according to a RAN standard (e.g., O-RAN standard), wherein each RAN is configured to support a different service provider, and wherein each RAN is configured to interface with a shared radio infrastructure to access RUs that are shared among the multiple RANs;

FIG. 5 is a block diagram of an exemplary radio infrastructure for a multi-operator RAN system in FIG. 4;

FIG. 6 is a table illustrating an exemplary list of frequency bands as shared radio resources and shared radio resources for each frequency band that can be selectively allocated in the radio infrastructure, including but not limited to the radio infrastructure FIGS. 4 and 5, to RANs in a multi-operator RAN system according to a radio resource configuration;

FIG. 7 is an exemplary radio resource configuration in a radio infrastructure, including but not limited to the radio infrastructure FIGS. 4 and 5, indicating an allocation of shared radio resources in the radio infrastructure for multiple RANs in a multi-operator RAN system;

FIG. 8 is a flow diagram illustrating an exemplary process flow for a shared radio resource allocation process for providing a shared radio resource configuration to a radio infrastructure for a multi-operator RAN system, including but not limited to the radio infrastructure in the multi-operator RAN system in FIGS. 4 and 5, and selectively allocating the shared radio resources to the multiple RANs in the multi-operator RAN system based on the radio resource configuration;

FIG. 9 is a schematic diagram of an exemplary multi-operator RAN system, including but not limited to the multi-operator RAN system of FIG. 4, wherein the multi-operator RAN system includes a radio infrastructure, including but not limited to the radio infrastructures in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process in FIG. 8;

FIG. 10 is a partial schematic cut-away diagram of an exemplary building infrastructure that includes a multi-operator RAN system, including but not limited to the multi-operator RAN system of FIG. 4, wherein the multi-operator RAN system includes a radio infrastructure, including but not limited to the radio infrastructures in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process in FIG. 8;

FIG. 11 is a schematic diagram of an exemplary mobile telecommunications environment that can include a multi-operator RAN system, including but not limited to the multi-operator RAN system of FIG. 4, wherein the multi-operator RAN system includes a radio infrastructure, including but not limited to the radio infrastructures in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process in FIG. 8; and

FIG. 12 is a schematic diagram of a representation of an exemplary computer system that can be included in or interfaced with any of the components in a RAN system, including but not limited to the multi-operator RAN system, including but not limited to the multi-operator RAN system of FIG. 4, wherein the multi-operator RAN system includes a radio infrastructure, including but not limited to the radio infrastructures in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process in FIG. 8.

### DETAILED DESCRIPTION

Embodiments disclosed herein optimized resource allocation and management of shared radio infrastructure for a multi-operator radio access network (RAN) system. For example, the RAN system may be an Open-RAN (O-RAN) system that includes one or more RANs that are compatible with the Open RAN standard set forth by the O-RAN Alliance and referred to herein as an “O-RAN system.” In exemplary embodiments, the RAN system includes multiple RANs that each provide a base station to provide a cell for a respective operator (e.g., a macrocell, small cell), which includes a set of signals intended to serve subscriber units (e.g., cellular devices) in a certain coverage area. The RANs are configured to be coupled to a respective “core network” of the cellular service provider (also known as operator or carrier). Each RAN also includes one or more radio nodes, also referred to as radio unit (RUs), that wirelessly transmits and receives signals to user devices. The RAN system can be configured for the multiple RANs to be able to share the RUs such that the RUs are capable of servicing signals for more than one cell of its coupled RAN(s). A benefit of multiple RANs sharing a RU is that the shared RU can serve the multiple service providers of the RAN(s) each employing their own separate base station functionality.

In exemplary aspects, the RAN system includes a radio infrastructure communicated coupled to the multiple RANs through a wired (e.g. eCPRI/O-RAN fronthaul interface) or wireless (RF) interface. The radio infrastructure may be a network hub for example. The radio infrastructure is configured to aggregate the downlink communication signals from the multiple RANs to be communicated by the shared RUs to user devices. In this manner, the radio infrastructure allows the RUs to be shared among the multiple RANs to serve multiple cells for multiple operators. The radio infrastructure is also configured to receive uplink communication signals from the RUs for the multiple cells and distribute the uplink communication signals to the appropriate RAN configured to support the operator cell of the uplink communication signals. To provide for the flexibility of the RAN system to support multiple RANs but with shared RUs, the radio infrastructure includes shared radio resources. However, these shared radio resources are finite resources. Thus, to avoid radio resource conflicts that may occur by the multiple RANs accessing a shared radio resource beyond its finite capability, in exemplary aspects, the radio infrastructure is configured to selectively allocate the shared radio resources to the multiple RANs based on a radio resource configuration. The radio resource configuration can be provided by one of the RANs in the RAN system to the radio infrastructure to be used to allocate the shared radio resources to the RANs or from a source outside of the RAN system. In this manner, a capability of a given shared radio resource is not accessible to multiple RANs in a manner that could result in a radio resource conflict due to concurrent access by the multiple RANs exceeding the maximum capability of such given shared radio resource.

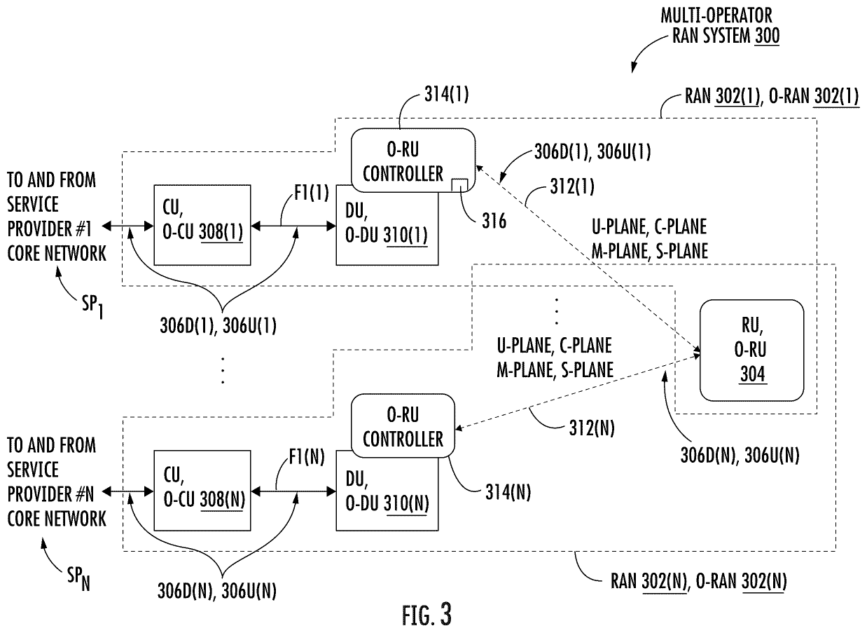

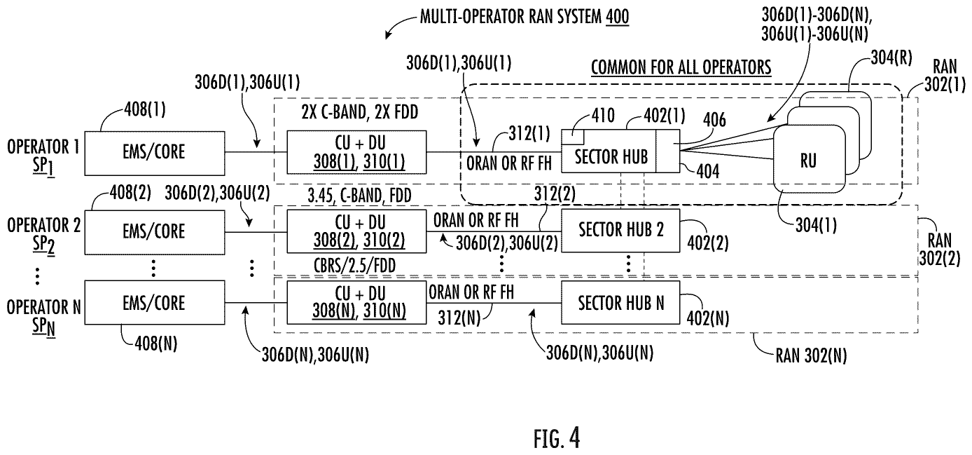

Example multi-operator RAN systems that include a radio infrastructure that has shared radio resources that can be allocated and managed for multiple RANs starts at FIG. 4. However, before discussing such multi-operator RAN systems, an exemplary RAN system that includes multiple higher-layer RAN entities configured to a shared RU without an intermediate agent device such that the shared RU includes a modified interface to be able to interface with the multiple higher-layer RAN entities is first described with regard to FIG. 3 below.

In this regard, FIG. 3 is an exemplary multi-operator RAN system 300 that includes multiple RANs 302(1)-302(N) each configured to support different service providers that are each configured to directly interface with a shared modified RU 304, wherein ‘N’ can be any positive whole number to signify the number of RANs. For example, the RANs 302(1)-302(N) may be O-RANs that are compatible with the Open-RAN standard set forth by the O-RAN Alliance, found at https://www.o-ran.org/. O-RAN is a set of specifications that specifies multiple options for functional divisions of a cellular base station between physical units and it also specifies the interface between these units. As an example, RANs 302(1)-302(N) can be small cell RANs that are configured to support multiple service providers SP₁-SP_{N} by distributing downlink communication signals 306D(1)-306D(N) (e.g., communication channels) for the multiple service providers SP₁-SP_{N}. The RANs 302(1)-302(N) both include a shared RU 304 that is configured to support one or more service providers SP₁-SP_{N} as signal sources (also known as “carriers” or “service operators”—e.g., mobile network operator (MNO). In this manner, the multiple RANs 302(1)-302(N) can share access to the RU 304 as opposed to each RAN 302(1)-302(N) having to include its own dedicated RUs. Providing for the ability of the RU 304 to be shared between the multiple RANs 302(1)-302(N) may be efficient in terms of cost and area, as it may be desired to provide antenna coverage for the multiple service providers SP₁-SP_{N} in the same physical location and area. The shared RU 304 is configured to wirelessly distribute the received downlink communication signals 306D(1)-306D(N) (e.g., in the form of communication channels) received from the respective service providers SP₁-SP_{N}, distributed by respective O-RAN Central Units (O-CUs) 308(1)-308(N) and O-RAN Distribution Units (O-DUs) 310(1)-310(N), to user client devices in the reception range of the RU 304. The shared RU 304 can include the lowest layers of a base station, and it is the entity that wirelessly transmits and receives signals to user devices. The O-CUs 308(1)-308(N) can include the highest layers of the base station and can be configured to be coupled to a “core network” of a respective cellular service provider SP₁-SP_{N} (also known as operator or carrier). The DUs 310(1)-310(N) can include middle layers of the base station to provide support for a respective cellular service provider SP₁-SP_{N}.

The downlink communication signals 306D(1)-306D(N) may be received from a base station (e.g., an eNB or gNB) or respective evolved packet cores (EPC) network of the respective service providers SP₁-SP_{N} through interface connections. Small cells can support one or more service providers in different channels within a frequency band to avoid interference and reduced signal quality as a result. The shared RU 304 is also configured to receive uplink communication signals 306U(1)-306U(N) (e.g., in the form of uplink communication channels) wirelessly received from user devices. The shared RU 304 is configured to distribute such received uplink communication signals 306U(1)-306U(N) to the respective service providers SP₁-SP_{N} through the respective O-DUs 310(1)-310(N) and O-CUs 308(1)-308(N). Secure communications tunnels are formed between the RU 304 and the respective service providers SP₁-SP_{N}. Thus, in this example, the RANs 302(1)-302(N) essentially appear as a single node (e.g., eNB in 4G or gNB in 5G) to the respective service providers SP₁-SP_{N}.

As discussed above, the RAN 302(1)-302(N) in the multi-operator RAN system 300 may be O-RANs that are compatible with the O-RAN standard, and thus are referred to as O-RANs 302(1)-302(N). In this regard, in the O-RANs 302(1)-302(N) configured as O-RANs, the functionality of the base stations (e.g., gNB, as called in the context of 5G) of the respective O-RANs 302(1)-302(N) is divided into three (3) functional units of an O-RAN central unit (O-CU) 308(1)-308(N), an O-RAN distribution unit (O-DU) 310(1)-310(N), and the shared RU 304 as an O-RAN RU (O-RU) 304. These components may run on different hardware platforms and reside at different locations. The shared O-RU 304 includes the lowest layers of the base station, and it is the entity that wirelessly transmits and receives signals to user devices. The O-CUs 308(1)-308(N) include the highest layers of the base station and is coupled to a “core network” of the cellular service provider. The O-DUs 310(1)-310(N) include the middle layers of the base station to provide support for a single cellular service provider (also known as operator or carrier). F1 interfaces F1(1)-F1(N) are connected between the respective O-CUs 308(1)-308(N) and the O-DUs 310(1)-310(N). A respective eCPRI/O-RAN fronthaul interface 312(1)-312(N) connects the respective O-DUs 310(1)-310(N) to the shared O-RU 304 that serve signals of the “cells” of the O-DUs 310(1)-310(N). A “cell” in this context is a set of signals of a given service provider SP₁-SP_{N} intended to serve subscriber units (e.g., cellular devices) in a certain area. The F1 interfaces F1(1)-F1(N) and eCPRI/O-RAN fronthaul interfaces 312(1)-312(N) use Ethernet protocol for conveying the data in this example. Therefore, Ethernet switches (not shown) may exist between the respective O-CUs 308(1)-308(N) and the O-DUs 310(1)-310(N), and between the respective O-DUs 310(1)-310(N) and the shared O-RU 304.

In the multi-operator RAN system 300 in FIG. 3, the fronthaul of the O-RANs 302(1)-302(N) consists of four planes: User Plane (U-Plane), Control Plane (C-Plane), Management Plane (M-Plane) and Synchronization Plane (S-Plane) according to the O-RAN standards. The U-Plane carries O-RAN conforming user data in the communication signals 308D(1)-308D(N), 308U(1)-308U(N) as I-Q samples between the respective O-DUs 310(1)-310(N) and the shared O-RU 304. The C-Plane is used by the O-DUs 310(1)-310(N) to dynamically provide the shared O-RU 304 with information about the structure of downlink user data plane data to be received from O-DUs 310(1)-310(N) (and to be sent towards the user equipment by the O-RU 304) and the structure of uplink user data plane to be sent to the O-DUs 310(1)-310(N) (as received from the user equipment). The M-Plane is used to provide O-RU 304 with software updated and all configuration information to properly operate the O-RAN Fronthaul, the air interface of the O-RU 304, and other O-RU 304 operations. The M-Plane is also used to convey alarms, key performance indicator (KPI) logs and other O-RU 304 originating information. The M-Plane is terminated on one end at the O-RU 304 and on the other end of a respective O-RU controller 314(1)-314(N) in each respective O-RAN 302(1)-302(N).

The O-RU controller 314(1)-314(N) can be a controller circuit (e.g., a microcontroller, a microprocessor) that can execute software and may be collocated with the function of the O-DUs 310(1)-310(N) or be a separate function from the O-DUs 310(1)-310(N). The S-Plane provides the O-RU 304 with time reference, typically using PTP 1588 protocol. The S-Plane is terminated at the O-RU 304 on one end and on the other end it is terminated at a timing source 316 (e.g., a clock circuit). The timing source may be collocated with an O-DU 310(1)-310(N) or be a separate entity from an O-DU 310(1)-310(N), such as a PTP Grand Master (GM) or a timing-aware Ethernet Switch typically configured as a boundary clock or transparent clock.

In a standard O-RAN configuration, each O-RU is not shared like shown in the multi-operator RAN system 300 in FIG. 3, but rather is coupled to a single O-RU Controller that is fully responsible for managing, configuring, and monitoring a respective O-RU. This model works well when the O-RU is used in a single operator (i.e., service provider) arrangement. However, if the O-RU is desired to be operated in a service provider neutral arrangement (i.e., a single O-RU is shared and utilized for multiple service operators simultaneously like the O-RU 304 in the multi-operator RAN system 300 in FIG. 3), each service operator would need to have its own M-Plane towards the O-RU 304. In this scenario using the multi-operator RAN system 300 in FIG. 3 as an example, the O-RU 304 would need to be customized in design to support multiple M-Plane terminations. The shared O-RU 304 would also need to be designed and customized to handle all complexities related to coordinating and managing these independent M-Planes. In other words, an O-RU that is designed to support standard O-RAN interfaces is not designed to multiple O-RAN communications planes to support multiple service providers, and thus could not be used in a RAN system, like the multi-operator RAN system 300 in FIG. 3. However, it is desired to not have to provide a customized O-RU that can support multiple M-Plane terminations in a RAN system to be able to provide for an O-RU to be shared between multiple RANs to support multiple service providers.

Challenges arise when there are multiple service providers (i.e. operators) SP₁-SP_{N} supplying signals within the multi-operator RAN system 300 that has the shared RU 304. The maintenance of such a system 300 to prevent configuration overlap and resulting conflicts to shared radio resources and ensure correct power distribution becomes a complex task. Currently, most check for conflicts to radio resources are conducted offline outside of the multi-operator RAN system 300, leading to potential errors and misconfigurations that are difficult to detect and debug.

In this regard, FIG. 4 is an exemplary multi-operator RAN system 400 that is similar to the multi-operator RAN system 300 in FIG. 3, with common elements shown with common element numbers. However, as discussed in more detail below, multi-operator RAN system 400 includes a shared radio infrastructure 404 that provides a hub for multiple RANs 302(1)-302(N) to access a plurality of shared RUs 304(1)-304(R). Each RAN 302(1)-302(N) includes a respective second hub 402(1)-402(N) as an interface between its respective DU 310(1)-310(N) and the RUs 304(1)-304(R). However, in this example, the second hub 402(1) provides a radio infrastructure 404 that supports radio resources for each of the RANs 302(1)-302(N) to interface with the shared RUs 304(1)-304(N). As discussed in more detail below, the radio infrastructure 404 is configured to aggregate the downlink communication signals 306D(1)-306D(N) from the multiple RANs 302(1)-302(N) to be communicated by the shared RUs 304(1)-304(R) to user devices according to a configuration for the RANs 302(1)-302(N). In this manner, the radio infrastructure 404 allows the RUs 304(1)-304(R) to be shared among the multiple RANs 302(1)-302(N) to serve multiple cells for the multiple operators SP₁-SP_{N}. The radio infrastructure 404 is also configured to receive uplink communication signals 306U(1)-306U(N) from the RUs 304(1)-304(R) and distribute the uplink communication signals 306U(1)-306U(N) to the appropriate RAN 302(1)-302(N) configured to support the operator SP₁-SP_{N} of the uplink communication signals 306U(1)-306U(N).

As also discussed below, to provide for the flexibility of the multi-operator RAN system 400 to support the multiple RANs 302(1)-302(N) with access to the shared RUs 304(1)-304(R), the radio infrastructure 404 includes shared radio resources 406 that are configured to be utilized to distribute communication signals 306D(1)-306D(N), 306U(1)-306U(N) between the core networks 408(1)-408(N) of the RANs 302(1)-302(N) and the shared RUs 304(1)-304(R).

Examples of shared radio resources 406 include radio signal input ports, antenna ports, power amplifiers and their configuration to support different frequency bands, downlink/uplink frequencies, bandwidth, and power sharing. However, these shared radio resources 406 are finite resources. Thus, to avoid radio resource conflicts that may occur by the multiple RANs 302(1)-302(N) accessing a shared radio resource 406 beyond its finite capability, in exemplary aspects, the radio infrastructure 404 is configured to selectively allocate the shared radio resources 406 to the multiple RANs 302(1)-302(N) based on a radio resource configuration 410. The radio resource configuration 410 can be provided by one of the RANs 302(1)-302(N) in the RAN system 400 to the radio infrastructure 404 to be used to allocate the shared radio resources 406 to the RANs 302(1)-302(N) or from a source outside of the RAN system 400. In this manner, a capability of a given shared radio resource 406 is not accessible to multiple RANs 302(1)-302(N) in a manner that could result in a radio resource conflict due to concurrent access by the multiple RANs 302(1)-302(N) exceeding the maximum capability of such given shared radio resource 406.

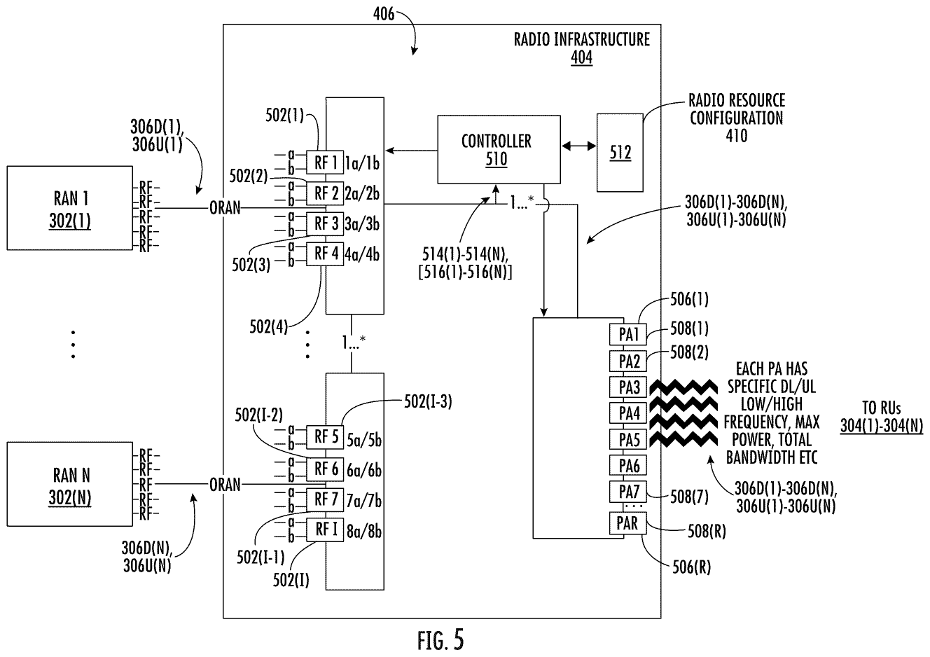

FIG. 5 is a block diagram illustrating exemplary detail of the radio infrastructure 404 in the multi-operator RAN system 400 in FIG. 4. In this regard, in this example, the radio infrastructure 404 includes a plurality of radio signal inputs 502(1)-502(I), each configured to be coupled to a RAN 302(1)-302(N), wherein each of the radio signal inputs 502(1)-502(I) is configured to carry a communication signal 306D, 306U. The radio signal inputs 502(1)-502(I) may be RF signal inputs configured to receive the downlink/uplink communication signals 306D, 306U as RF radio signals or baseband inputs configured to receive the downlink/uplink communication signals 306D, 306U as baseband signals. The radio infrastructure 404 also includes a plurality of power amplifiers (PAs) 506(1)-506(R) that are each coupled to a respective antenna port 508(1)-508(R) that is configured to be coupled to a respective RU 304(1)-304(R). The PAs 506(1)-506(R) are configured to process the downlink and uplink communication signals 306D(1)-306D(N), 306U(1)-306U(N), such as the amplify such signals. The PAs 506(1)-506(R) can each be part of respective RF chain circuits. The PAs 506(1)-506(R) can be configured to support particularly frequency bands, frequencies within the supported frequency bands, and at a configured bandwidth as shared radio resources 406.

As discussed above, it is desired to be able to allocate the shared radio resources 406 to the multiple RANs 302(1)-302(N). In this example, the radio infrastructure 404 includes a controller 510, which is a circuit that may include a processor or CPU configured to execute computer program instructions or consist entirely of circuits (e.g., a FPGA, logic circuits, etc). The controller 510 is configured to control distribution of communication signals 306D, 306U between the RANs 302(1)-302(N) and the RUs 304(1)-304(N) based on radio resource information 512 in the radio resource configuration 410 indicating an allocation of shared radio resources 406 to the RANs 302(1)-302(N). The controller 510 is configured to receive RAN radio resource sharing requests 514(1)-514(N) each comprising respective RAN shared resource information 516(1)-516(N) for the RANs 302(1)-302(N) indicating their desired allocation of the shared radio resources 406 to their respective RAN 302(1)-302(N). The controller 510 is configured to receive configure the radio resource information 512 in the radio resource configuration 410 based on the RAN shared resource information 516(1)-516(N) provided in the respective RAN radio resource sharing requests 514(1)-514(N) to allocate the shared radio resources 406 to the RANs 302(1)-302(N).

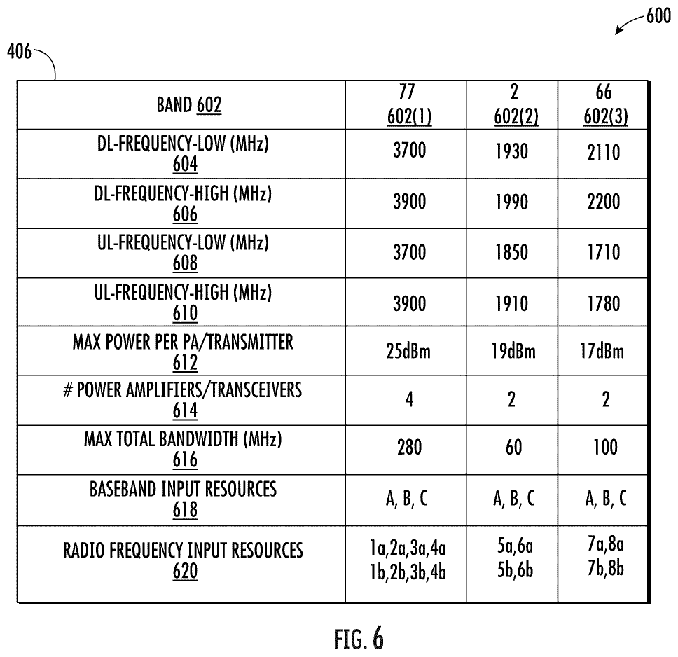

FIG. 6 is a table 600 illustrating an exemplary shared radio resources 406 that can be allocated by radio infrastructure 404 on a per RAN 302(1)-302(N) basis for each of the RAN 302(1)-302(N) in the multi-operator RAN system 400 in FIG. 4 for being configured with access to one or more of the shared RUs 304(1)-304(N) as shared radio resources. The RAN radio resource sharing requests 514(1)-514(N) should be controlled to make sure that the requested RAN shared resource information 516(1)-516(N) used to control the allocation of the shared radio resources 406 does not cause a conflict in the-operator RAN system 400. The table 600 in FIG. 6 illustrates exemplary maximum settings for the shared radio resources 406. As shown in FIG. 6, one example of a shared radio resource 406 is frequency band 602. In this example, the radio infrastructure 404 supports three (3) frequency bands 602 of band 77, band 2, and band 66 602(1)-602(3). The controller 510 can configure radio resource information 512 in a radio resource configuration 410 to support any of the RANs 302(1)-302(N) being coupled to one or more of the RUs 304(1)-304(N) to support one or more of the frequency bands 602(1)-602(3). As also shown in FIG. 6, in this example, the radio infrastructure 404 supports a lower and higher downlink frequency 604, 606 for the supported frequency bands 602. The controller 510 can configure radio resource information 512 in a radio resource configuration 410 to support set the lower and higher downlink frequency 604, 606 for any supported frequency bands 602. As also shown in FIG. 6, in this example, the radio infrastructure 404 supports a lower and higher uplink frequency 608, 610 for the supported frequency bands 602. The controller 510 can configure radio resource information 512 in a radio resource configuration 410 to support set the lower and higher uplink frequency 608, 610 for any supported frequency bands 602.

As also shown in FIG. 6, in this example, the radio infrastructure 404 also supports a maximum power 612 per PA 506(1)-506(R) for the supported frequency bands 602. The controller 510 can configure radio resource information 512 in a radio resource configuration 410 to support set the maximum power 612 for any supported frequency bands 602. As also shown in FIG. 6, in this example, the radio infrastructure 404 also supports a number of PAs 614 configured to be used for the supported frequency bands 602. The controller 510 can configure radio resource information 512 in a radio resource configuration 410 to support allocating the number of PAs 614 among the PAs 506(1)-506(R) for any supported frequency bands 602. As also shown in FIG. 6, in this example, the radio infrastructure 404 also supports a maximum total bandwidth 616 configured to be used for each of the supported frequency bands 602. The controller 510 can configure radio resource information 512 in a radio resource configuration 410 to support set the maximum total bandwidth 616 to allocate to each of the frequency bands 602 configured to be supported.

As also shown in FIG. 6, in this example, the radio infrastructure 404 also supports a baseband input 618 indicating which radio signal inputs 502(1)-502(I) are allocated to a RAN 302(1)-302(R) to support baseband signals for the respective supported frequency bands 602. The controller 510 can configure radio resource information 512 in a radio resource configuration 410 to support set the baseband input 618 to allocate which radio signal inputs 502(1)-502(I) are allocated for each of the frequency bands 602 configured to be supported. As also shown in FIG. 6, in this example, the radio infrastructure 404 also supports a RF signal input 620 indicating which radio signal inputs 502(1)-502(I) are allocated to a RAN 302(1)-302(R) to support RF radio signals for the respective supported frequency bands 602. The controller 510 can configure radio resource information 512 in a radio resource configuration 410 to support set the RF signal input 620 to allocate which radio signal inputs 502(1)-502(I) are allocated for each of the frequency bands 602 configured to be supported.

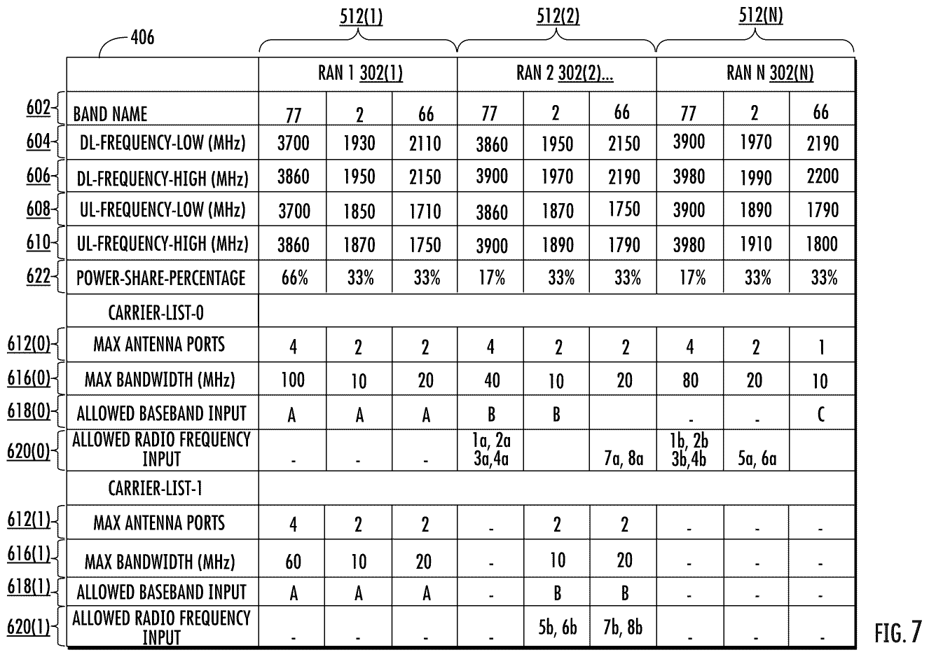

FIG. 7 is an exemplary radio resource configuration 410 in the radio infrastructure 404 showing radio resource information 512(1)-512(N) for each of the RAN 302(1)-302(N) to provide information on a requested shared allocation of the shared radio resources 406. In this example, the overall shared radio resources 406 are divided among the RANs 302(1)-302(N) as shown. The sharing extends to all frequency bands 602 and bandwidths 616, as well as power distribution. The radio resource information 512(1)-512(N) in this example also includes power sharing 622 as a percentage of the power of the shared radio resources 406 allocated to each supported frequency band 602 for each RAN 302(1)-302(N). Note that the radio resource information 512(1)-512(N) in the radio resource configuration 410 in FIG. 7 includes some settings per multiple carriers 0, 1 in the event that a RAN 302(1)-302(N) supports multiple carriers.

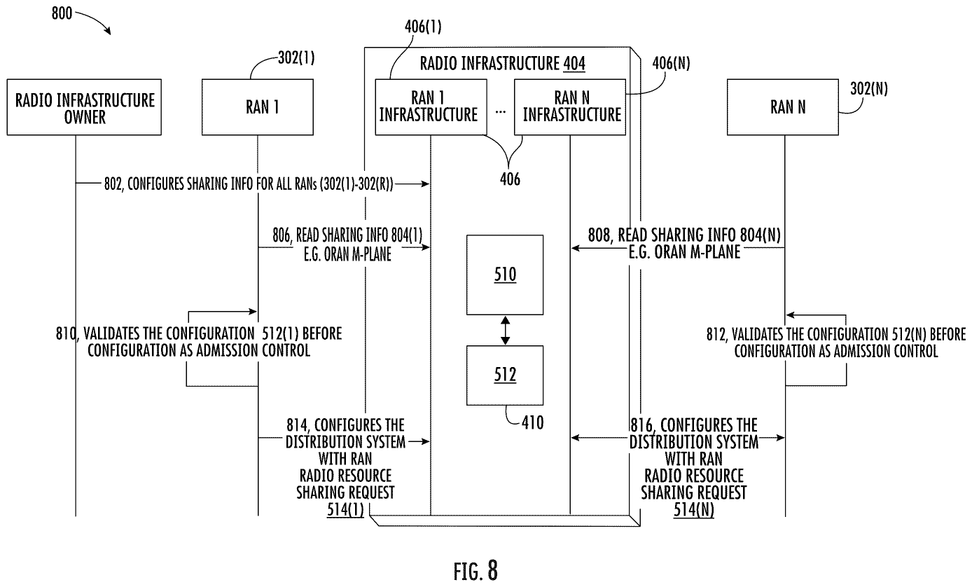

FIG. 8 is a flow diagram illustrating an exemplary process flow for a shared radio resource allocation process 800 for providing a shared radio resource configuration to a radio infrastructure for a multi-operator RAN system, including but not limited to the radio infrastructure 404 for the multi-operator RAN system 400 in FIGS. 4 and 5, and selectively allocating shared radio resources to the multiple RANs in the multi-operator RAN system based on the radio resource configuration. The process 800 is described with reference to the multi-operator RAN system 400 and radio infrastructure 404 in FIGS. 4 and 5.

In this regard, as shown in FIG. 8, a first step in the shared radio resource allocation process 800 can be for a RAN 302(1)-302(N) to provide radio resource information 512 for the RANs 302(1)-302(4) to be used to provide the radio resource configuration 410 (block 802 in FIG. 8). The radio resource information 512 indicates the possible allocation of the shared radio resources 406 available to the RANs 302(1)-302(R). The RANs 302(1)-302(N) are then configured to send a respective radio resource sharing request 804(1)-804(N) to the radio infrastructure 404 to access the radio resource information 512(1)-512(N) from radio resource information 512 specific to its RAN 302(1)-302(N) (blocks 806 and 808 in FIG. 8). The RANs 302(1)-302(N) can then validate the received respective radio resource information 512(1)-512(N) to determine if a radio resource configuration for the RAN 302(1)-302(N) according to its respective radio resource information 512(1)-512(N) (blocks 810 and 812 in FIG. 8). In response to the validation of the received respective radio resource information 512(1)-512(N) by the RANs 302(1)-302(N), the respective RANs 302(1)-302(N) can provide a respective RAN radio resource sharing request 514(1)-514(N) to the radio infrastructure 404 to be used to configure the respective radio resource information 512(1)-512(N) for the respective RANs 302(1)-302(N) as the radio resource configuration 410 to be used to allocated shared radio resources 406 for RANs 302(1)-302(N) communication to the shared RUs 304(1)-304(R) (blocks 814 and 816 in FIG. 8).

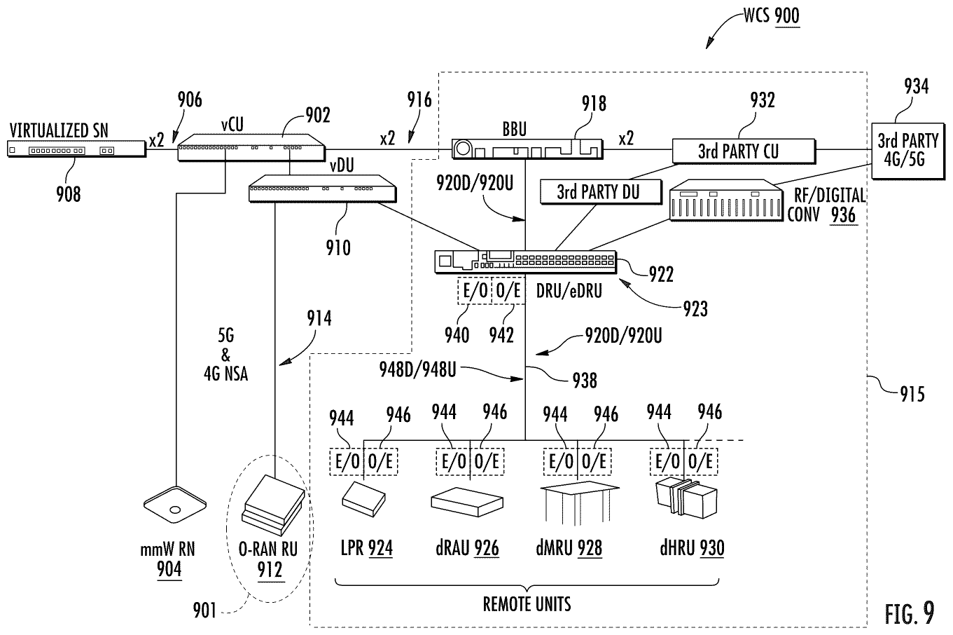

FIG. 9 is a schematic diagram of an exemplary WCS 900 that can include one or RAN systems implemented according to a RAN standard (e.g., O-RAN standard), including but not limited to the RAN system 400 of FIGS. 4 and 5, and with a radio infrastructure 923, including but not limited to the radio infrastructure 404 in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process 800 in FIG. 6.

The WCS 900 supports both legacy 4G LTE, 4G/5G non-standalone (NSA), and 5G standalone communications systems. As shown in FIG. 9, a centralized services node 902 (which can be a CU described above) is provided that is configured to interface with a core network to exchange communications data and distribute the communications data as radio signals to remote units, which can be the RUs described above. In this example, the centralized services node 902 is configured to support distributed communications services to an mmWave radio node 904. The mmWave radio node 904 is an example of a wireless device that can be configured to selectively control whether received transmit channels are transmitted through an antenna array. Despite that only one mmWave radio node 904 is shown in FIG. 9, it should be appreciated that the WCS 900 can be configured to include additional mmWave radio nodes 904, as needed. The functions of the centralized services node 902 can be virtualized through an x2 interface 906 to another services node 908. The centralized services node 902 can also include one or more internal radio nodes that are configured to be interfaced with a DU 910 (which can be a virtual DU and/or a DU described above) to distribute communication signals (e.g., communications channels) to one or more O-RAN RUs 912 that are configured to be communicatively coupled through an O-RAN interface 914. The O-RAN RUs 912 are another example of a wireless device that can be configured to selectively control whether received transmit channels are transmitted through an antenna array. The O-RAN RUs 912 are each configured to communicate downlink and uplink communication signals in the coverage cell(s) 901.

The centralized services node 902 can also be interfaced with a DCS 915 through an x2 interface 916. Specifically, the centralized services node 902 can be interfaced with a digital baseband unit (BBU) 918 in the DCS that can provide a digital signal source to the centralized services node 902. The digital BBU 918 may be configured to provide a signal source to the centralized services node 902 to provide electrical downlink communication signals 920D (electrical downlink communication signals 920D can include downlink channels) to a digital routing unit (DRU) 922 as part of a digital DAS. The digital BBU 918 may be configured to include the radio infrastructure 923, which could be the radio infrastructure 404 in FIGS. 4 and 5. The DRU 922 is configured to split and distribute the electrical downlink communication signals 920D to different types of remote wireless devices, including a low-power remote unit (LPR) 924, a radio antenna unit (dRAU) 926, a mid-power remote unit (dMRU) 928, and/or a high-power remote unit (dHRU) 930. The DRU 922 is also configured to combine electrical uplink communication signals 920U (electrical uplink communication signals 920U can include uplink channels) received from the LPR 924, the dRAU 926, the dMRU 928, and/or the dHRU 930 and provide the combined electrical uplink communication signals 920U to the digital BBU 918. The digital BBU 918 is also configured to interface with a third-party central unit 932 and/or an analog source 934 through a radio frequency (RF)/digital converter 936.

The DRU 922 may be coupled to the LPR 924, the dRAU 926, the dMRU 928, an/or the dHRU 930 via an optical fiber-based communications medium 938. In this regard, the DRU 922 can include a respective electrical-to-optical (E/O) converter 940 and a respective optical-to-electrical (O/E) converter 942. Likewise, each of the LPR 924, the dRAU 926, the dMRU 928, and the dHRU 930 can include a respective E/O converter 944 and a respective O/E converter 946.

The E/O converter 940 at the DRU 922 is configured to convert the electrical downlink communication signals 920D into optical downlink communication signals 920D for distribution to the LPR 924, the dRAU 926, the dMRU 928, and/or the dHRU 930 via the optical fiber-based communications medium 938. The O/E converter 950 at each of the LPR 924, the dRAU 926, the dMRU 928, and/or the dHRU 930 is configured to convert the optical downlink communication signals 920D back to the electrical downlink communication signals 920D. The E/O converter 944 at each of the LPR 924, the dRAU 926, the dMRU 928, and the dHRU 930 is configured to convert the electrical uplink communication signals 920U into optical uplink communication signals 920U. The O/E converter 942 at the DRU 922 is configured to convert the optical uplink communication signals 920U back to the electrical uplink communication signals 920U.

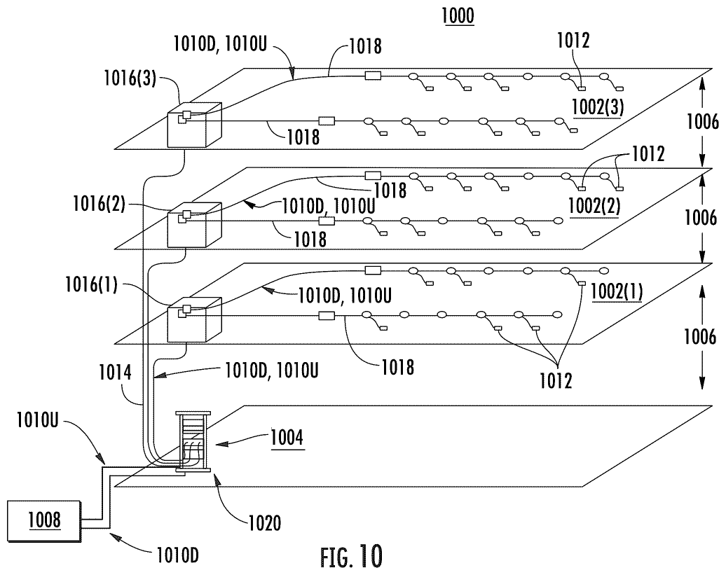

FIG. 10 is a partial schematic cut-away diagram of an exemplary building infrastructure 1000 that includes an exemplary RAN system 1002, including but not limited to the RAN system 400 of FIGS. 4 and 5, and with a radio infrastructure 1020, including but not limited to the radio infrastructure 404 in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process 800 in FIG. 6. The building infrastructure 1000 in this embodiment includes a first (ground) floor 1002(1), a second floor 1002(2), and a third floor 1002(3). The floors 1002(1)-1002(3) are serviced by one or more RANs 1004 to provide antenna coverage areas 1006 in the building infrastructure 1000. The RANs 1004 are communicatively coupled to a core network 1008 to receive downlink communication signals 1010D (downlink communication signals 1010D can include downlink channels) from the core network 1008. The RANs 1004 are communicatively coupled to a respective plurality of RUs 1012 to distribute the downlink communication signals 1010D to the RUs 1012 and to receive uplink communication signals 1010U (uplink communication signals 1010U can include uplink channels) from the RUs 1012, as previously discussed above. Any RU 1012 can be shared by any of the multiple RANs 1004.

The downlink communication signals 1010D and the uplink communication signals 1010U communicated between the RANs 1004 and the RUs 1012 are carried over a riser cable 1014. The riser cable 1014 may be routed through interconnect units (ICUs) 1016(1)-1016(3) dedicated to each of the floors 1002(1)-1002(3) that route the downlink communication signals 1010D and the uplink communication signals 1010U to the RUs 1012 and also provide power to the RUs 1012 via array cables 1018.

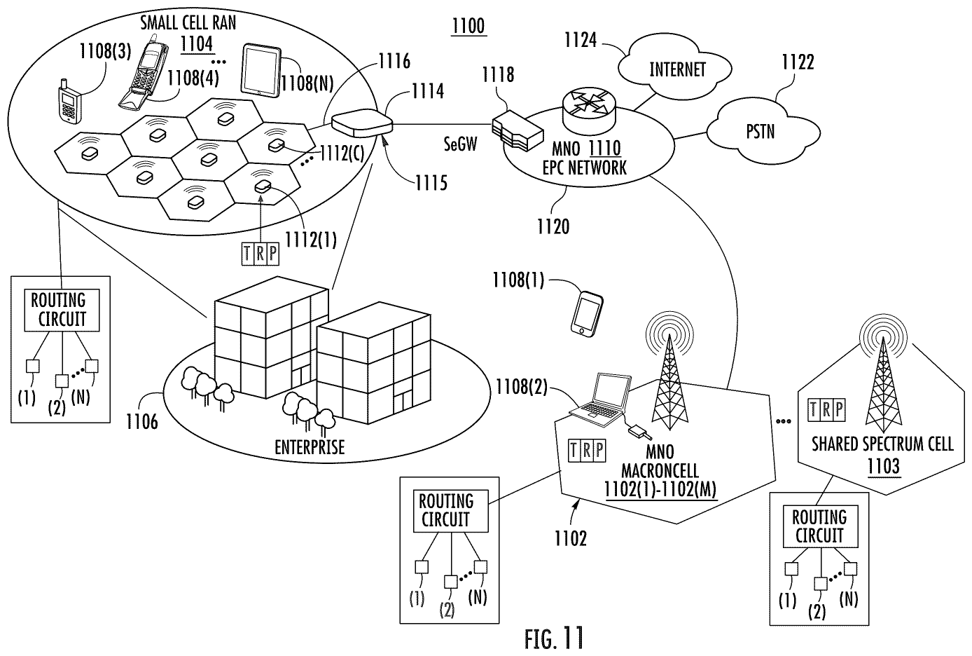

FIG. 11 is a schematic diagram of an exemplary mobile telecommunications RAN system 1100 (also referred to as “RAN system 1100”) that can include, but is not limited to, including but not limited to the RAN system 400 of FIGS. 4 and 5, and with a radio infrastructure 1020, including but not limited to the radio infrastructure 404 in FIGS. 4 and 5, that has shared radio resources that can be accessed by the multiple RANs to interface the multiple RANs with shared RUs, and wherein the radio infrastructure is configured to selectively allocated its shared radio resources to the multiple RANs based on a radio resource configuration, including according, but not limited to, the shared radio resource allocation process 800 in FIG. 6.

In this regard, RAN system 1100 includes exemplary macrocell RANs 1102(1)-1102(M) (“macrocells 1102(1)-1102(M)”) and an exemplary small cell RAN 1104 located within an enterprise environment 1106 and configured to service mobile communications between a user mobile communications device 1108(1)-1108(N) to a mobile network operator (MNO) 1110. A serving RAN for the user mobile communications devices 1108(1)-1108(N) is a RAN or cell in the RAN in which the user mobile communications devices 1108(1)-1108(N) have an established communications session with the exchange of mobile communication signals for mobile communications. Thus, a serving RAN may also be referred to herein as a serving cell. For example, the user mobile communications devices 1108(3)-1108(N) in FIG. 11 are being serviced by the small cell RAN 1104, whereas the user mobile communications devices 1108(1) and 1108(2) are being serviced by the macrocell 1102. The macrocell 1102 is an MNO macrocell in this example. The macrocell 1102 can be or include a wireless device(s) that can be configured to selectively control whether received transmit channels are transmitted through an antenna array of the wireless device. However, a shared spectrum RAN 1103 (also referred to as “shared spectrum cell 1103”) includes a macrocell in this example and supports communications on frequencies that are not solely licensed to a particular MNO, such as CBRS for example, and thus may service user mobile communications devices 1108(1)-1108(N) independent of a particular MNO. The macrocell 1102 can be or include a wireless device(s) that can be configured to selectively control whether received transmit channels are transmitted through an antenna array of the wireless device. The macrocell 1102 can be a wireless device that can be configured to selectively control whether received transmit channels are transmitted through an antenna array of the wireless device. For example, the shared spectrum cell 1103 may be operated by a third party that is not an MNO and wherein the shared spectrum cell 1103 supports CBRS. The MNO macrocell 1102, the shared spectrum cell 1103, and the small cell RAN 1104 may be neighboring radio access systems to each other, meaning that some or all can be in proximity to each other such that a user mobile communications device 1108(3)-1108(N) may be able to be in communications range of two or more of the MNO microcell(s) 1102, the shared spectrum cell 1103, and the small cell RAN 1104 depending on the location of the user mobile communications devices 1108(3)-1108(N).

In FIG. 11, the RAN system 1100 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The RAN system 1100 includes the enterprise environment 1106 in which the small cell RAN 1104 is implemented. The small cell RAN 1104 includes a plurality of small cell radio nodes 1112(1)-1112(C), which are wireless devices that can be configured to selectively control whether received transmit channels are transmitted through an antenna array of the wireless devices. Each small cell radio node 1112(1)-1112(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 11, the small cell RAN 1104 includes one or more services nodes (represented as a single services node 1114) that manage and control the small cell radio nodes 1112(1)-1112(C). In alternative implementations, the management and control functionality may be incorporated into a radio node, distributed among nodes, or implemented remotely (i.e., using infrastructure external to the small cell RAN 1104). The small cell radio nodes 1112(1)-1112(C) are coupled to the services node 1114 over a direct or local area network (LAN) connection 1116 as an example, typically using secure IPsec tunnels. The small cell radio nodes 1112(1)-1112(C) can include multi-operator radio nodes. A radio infrastructure 1115, like the radio infrastructure 404 in FIGS. 4 and 5, can be provided allocate shared radiou resources between the services node 1114 and shared small cell radio nodes 1112(1)-1112(C). The services node 1114 aggregates voice and data traffic from the small cell radio nodes 1112(1)-1112(C) and provides connectivity over an IPsec tunnel to a security gateway (SeGW) 1118 in a network 1120 (e.g., evolved packet core (EPC) network in a 4G network, or 5G Core in a 5G network) of the MNO 1110. The network 1120 is typically configured to communicate with a public switched telephone network (PSTN) 1122 to carry circuit-switched traffic, as well as for communicating with an external packet-switched network such as the Internet 1124. The RAN system 1100 also generally includes a node (e.g., eNodeB or gNodeB) base station, or “macrocell” 1102. The radio coverage area of the macrocell 1102 is typically much larger than that of a small cell where the extent of coverage often depends on the base station configuration and surrounding geography. Thus, a given user mobile communications device 1108(3)-1108(N) may achieve connectivity to the network 1120 (e.g., EPC network in a 4G network, or 5G Core in a 5G network) through either a macrocell 1102 or small cell radio node 1112(1)-1112(C) in the small cell RAN 1104 in the RAN system 1100.

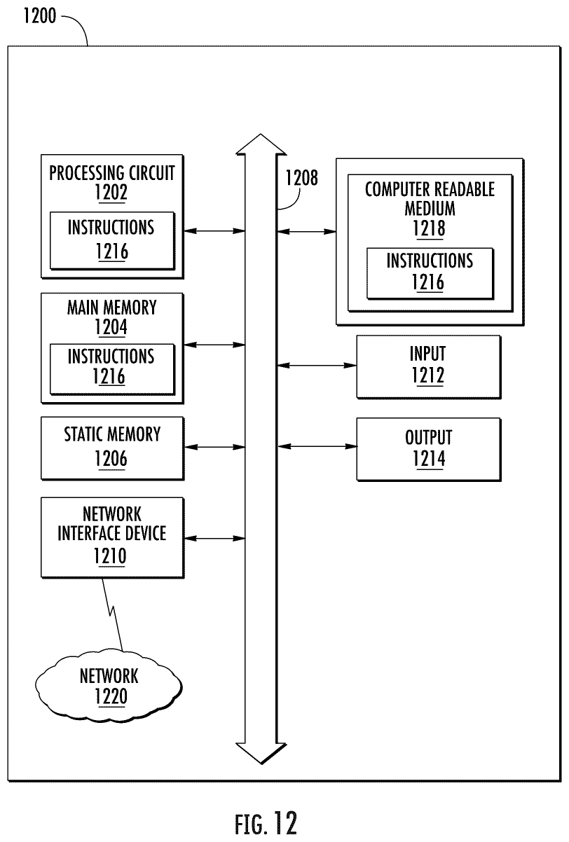

Any of the circuits, components, devices, modules described herein, including but not limited to radio infrastructure 404 in FIGS. 4 and 5 can include or be included in a computer system 1200, such as that shown in FIG. 12, to carry out their functions and operations as described herein. With reference to FIG. 12, the computer system 1200 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1200 in this embodiment includes a processing circuit or processor 1202, a main memory 1204 (e.g., read-only memory (ROM), flash memory, dynamic random access memory (DRAM) such as synchronous DRAM (SDRAM), etc.), and a static memory 1206 (e.g., flash memory, static random access memory (SRAM), etc.), which may communicate with each other via a data bus 1208. Alternatively, the processing circuit 1202 may be connected to the main memory 1204 and/or static memory 1206 directly or via some other connectivity means. The processing circuit 1202 may be a controller, and the main memory 1204 or static memory 1206 may be any type of memory.

The processing circuit 1202 represents one or more general-purpose processing circuits such as a microprocessor, central processing unit, or the like. More particularly, the processing circuit 1202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1202 is configured to execute processing logic in instructions 1216 for performing the operations and steps discussed herein.

The computer system 1200 may further include a network interface device 1210. The computer system 1200 also may or may not include an input 1212 to receive input and selections to be communicated to the computer system 1200 when executing instructions. The computer system 1200 also may or may not include an output 1214, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1200 may or may not include a data storage device that includes instructions 1216 stored in a computer-readable medium 1218. The instructions 1216 may also reside, completely or at least partially, within the main memory 1204 and/or within the processing circuit 1202 during execution thereof by the computer system 1200, the main memory 1204 and the processing circuit 1202 also constituting the computer-readable medium 1218. The instructions 1216 may further be transmitted or received over a network 1220 via the network interface device 1210.

While the computer-readable medium 1218 is shown in an exemplary embodiment to be a single medium, the term “computer-readable medium” should be taken to include a single medium or multiple media (e.g., a centralized or distributed database, and/or associated caches and servers) that store the one or more sets of instructions. The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. The term “computer-readable medium” and “machine-readable medium” shall also be taken to include any medium that is capable of storing, encoding or carrying a set of instructions for execution by the processing circuit and that cause the processing circuit to perform any one or more of the methodologies of the embodiments disclosed herein. For example, a computer-readable medium or a machine-readable medium includes a machine-readable storage medium (e.g., read only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server. It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A radio infrastructure for a multiple (multi-) operator radio access network (RAN) system, the radio infrastructure configured to be communicatively coupled to a plurality of remote units (RUs) and a plurality of radio access networks (RANs), the radio infrastructure comprising:
shared radio resources configured to be utilized to distribute communication signals; and
a controller configured to:
control distribution of communication signals between the plurality of RANs and the plurality of RUs based on radio resource information in a radio resource configuration indicating an allocation of shared radio resources to each of the plurality of RANs;
receive a plurality of RAN radio resource sharing requests each comprising RAN shared resource information for each of the plurality of RANs; and
configure the radio resource information in the radio resource configuration based on the RAN shared resource information in the plurality of RAN radio resource sharing requests to allocate the shared radio resources to the plurality of RANs.

2. The radio resource of claim 1, wherein:
the shared radio resources comprises a plurality of supported frequency bands;
the plurality of RAN radio resource sharing requests each comprise at least one requested frequency band of the plurality of supported frequency bands; and
the controller configured to:
configure the radio resource information in the radio resource configuration with the at least one frequency band requested to be supported for each of the plurality of RANs in the plurality of RAN radio resource sharing requests; and
control distribution of the communication signals between the plurality of RANs and the plurality of RUs in the at least one frequency band radio allocated for each of the plurality of RANs in the radio resource information in the radio resource configuration.

3. The radio resource of claim 2, wherein:
the plurality of RAN radio resource sharing requests each further comprise a downlink frequency for each of the at least one requested frequency bands of the plurality of supported frequency bands; and
the controller further configured to:
configure the radio resource information in the radio resource configuration with the downlink frequency for each of at least one frequency bands requested to be supported for each of the plurality of RANs in the plurality of RAN radio resource sharing requests; and
the controller configured to:
control distribution of communication signals by being configured to control distribution of downlink communication signals from the plurality of RANs to the plurality of RUs at the downlink frequency allocated for each of at least one frequency bands for each of the plurality of RANs in the radio resource information in the radio resource configuration.

4. The radio resource of claim 3, wherein:
the plurality of RAN radio resource sharing requests each further comprise a downlink bandwidth for each downlink frequency of the at least one requested frequency bands of the plurality of supported frequency bands; and
the controller further configured to:
configure the radio resource information in the radio resource configuration with the downlink bandwidth for each downlink frequency of the at least one frequency band requested to be supported for each of the plurality of RANs in the plurality of RAN radio resource sharing requests; and
the controller configured to:
control distribution of communication signals by being configured to control distribution of the downlink communication signals from the plurality of RANs to the plurality of RUs at the downlink frequency within the downlink bandwidth allocated for each of at least one frequency bands for each of the plurality of RANs in the radio resource information in the radio resource configuration.

5. The radio resource of claim 2, wherein:
the plurality of RAN radio resource sharing requests each further comprise an uplink frequency for each of the at least one requested frequency bands of the plurality of supported frequency bands; and
the controller further configured to:
configure the radio resource information in the radio resource configuration with the uplink frequency for each of at least one frequency bands requested to be supported for each of the plurality of RANs in the plurality of RAN radio resource sharing requests; and
the controller configured to:
control distribution of communication signals by being configured to control distribution of uplink communication signals from the plurality of RUs to the plurality of RANs at the uplink frequency allocated for each of at least one frequency bands for each of the plurality of RANs in the radio resource information in the radio resource configuration.

6. The radio resource of claim 5, wherein:
the plurality of RAN radio resource sharing requests each further comprise an uplink bandwidth for each uplink frequency of the at least one requested frequency bands of the plurality of supported frequency bands; and
the controller further configured to:
configure the radio resource information in the radio resource configuration with the uplink bandwidth for each uplink frequency of the at least one frequency band requested to be supported for each of the plurality of RANs in the plurality of RAN radio resource sharing requests; and
the controller configured to:
control distribution of communication signals by being configured to control distribution of the uplink communication signals from the plurality of RUs to the plurality of RANs at the uplink frequency within the uplink bandwidth allocated for each of at least one frequency bands for each of the plurality of RANs in the radio resource information in the radio resource configuration.

7. The radio resource of claim 2, wherein:
the plurality of RAN radio resource sharing requests each further comprise power sharing information between the at least one requested frequency band of the plurality of supported frequency bands; and
the controller further configured to:
configure the radio resource information in the radio resource configuration with the power sharing information indicating power share for each of the least one frequency bands requested to be supported for each of the plurality of RANs in the plurality of RAN radio resource sharing requests; and
the controller configured to:
control distribution of communication signals by being configured to control power sharing for the communication signals distributed between the plurality of RANs and the plurality of RUs based on the power sharing information for each of the at least one frequency bands allocated for each of the plurality of RANs in the radio resource information in the radio resource configuration.

8. The radio resource of claim 1, wherein:
the shared radio resources comprises a plurality of radio signal inputs each configured to be coupled to a RAN of the plurality of RANs, wherein each of the radio signal inputs is configured to carry a communication signal of the communication signals;
the plurality of RAN radio resource sharing requests each comprise at least one requested radio signal input of the plurality of radio signal inputs; and
the controller configured to:
configure the radio resource information in the radio resource configuration with the at least one radio signal input requested to be supported for each of the plurality of RANs in the plurality of RAN radio resource sharing requests; and
control distribution of the communication signals between the plurality of RANs and the plurality of RUs over the at least one radio signal input allocated for each of the plurality of RANs in the radio resource information in the radio resource configuration.

9. The radio resource of claim 8, wherein the plurality of radio signal inputs comprises a plurality of baseband signal inputs, wherein:
the shared radio resources comprise a plurality of baseband signal inputs, each configured to be coupled to a RAN of the plurality of RANs, wherein each of the radio signal inputs is configured to carry a baseband communication signal of the communication signals;
the plurality of RAN radio resource sharing requests each comprise at least one requested baseband signal input of the plurality of baseband signal inputs; and
the controller configured to:
configure the radio resource information in the radio resource configuration with the at least one baseband signal input requested to be supported for each of the plurality of RANs in the plurality of RAN radio resource sharing requests; and
control distribution of the communication signals between the plurality of RANs and the plurality of RUs over the at least one baseband signal input allocated for each of the plurality of RANs in the radio resource information in the radio resource configuration.

10. The radio resource of claim 8, wherein the plurality of radio signal inputs comprise a plurality of radio-frequency (RF) signal inputs, wherein:
the shared radio resources comprises a plurality of RF signal inputs each configured to be coupled to a RAN of the plurality of RANs, wherein each of the radio signal inputs is configured to carry an RF communication signal of the communication signals;
the plurality of RAN radio resource sharing requests each comprise at least one requested RF signal input of the plurality of RF signal inputs; and
the controller configured to:
configure the radio resource information in the radio resource configuration with the at least one RF signal input requested to be supported for each of the plurality of RANs in the plurality of RAN radio resource sharing requests; and
control distribution of the communication signals between the plurality of RANs and the plurality of RUs over the at least one RF signal input allocated for each of the plurality of RANs in the radio resource information in the radio resource configuration.

11. The radio resource of claim 1, wherein:
the shared radio resources comprise a plurality of antenna ports, each configured to be coupled to a RU of the plurality of RUs, wherein each of the antenna ports is configured to carry a communication signal of the communication signals;
the plurality of RAN radio resource sharing requests each comprise at least one requested antenna port of the plurality of antenna ports; and
the controller configured to:
configure the radio resource information in the radio resource configuration with the at least one antenna port requested to be supported for each of the plurality of RANs in the plurality of RAN radio resource sharing requests; and
control distribution of the communication signals between the plurality of RANs and the plurality of RUs over the at least one antenna port allocated for each of the plurality of RANs in the radio resource information in the radio resource configuration.

12. A method of allocating shared radio resources in a radio infrastructure in a multiple (multi-) operator radio access network (RAN) system, comprising
controlling distribution of communication signals between a plurality of RANs and a plurality of RUs based on radio resource information in a radio resource configuration indicating an allocation of shared radio resources to each of the plurality of RANs;
receiving a plurality of RAN radio resource sharing requests each comprising RAN shared resource information for each of the plurality of RANs; and
configuring the radio resource information in the radio resource configuration based on the RAN shared resource information in the plurality of RAN radio resource sharing requests to allocate the shared radio resources to the plurality of RANs.

13. The method of claim 12, wherein the plurality of RAN radio resource sharing requests each comprise at least one requested frequency band of the plurality of supported frequency bands, and comprising:
configuring the radio resource information in the radio resource configuration with the at least one frequency band requested to be supported for each of the plurality of RANs in the plurality of RAN radio resource sharing requests; and
controlling distribution of the communication signals between the plurality of RANs and the plurality of RUs in the at least one frequency band radio allocated for each of the plurality of RANs in the radio resource information in the radio resource configuration.

14. The method of claim 13, wherein the plurality of RAN radio resource sharing requests each further comprises a downlink frequency for each of the at least one requested frequency bands of the plurality of supported frequency bands, and comprising:
configuring the radio resource information in the radio resource configuration with the downlink frequency for each of at least one frequency bands requested to be supported for each of the plurality of RANs in the plurality of RAN radio resource sharing requests; and
controlling distribution of communication signals by being configured to control distribution of downlink communication signals from the plurality of RANs to the plurality of RUs at the downlink frequency allocated for each of at least one frequency bands for each of the plurality of RANs in the radio resource information in the radio resource configuration.

15. The method of claim 14, wherein:
the plurality of RAN radio resource sharing requests each further comprises a downlink bandwidth for each downlink frequency of the at least one requested frequency bands of the plurality of supported frequency bands; and
further comprising:
configuring the radio resource information in the radio resource configuration with the downlink bandwidth for each downlink frequency of the at least one frequency band requested to be supported for each of the plurality of RANs in the plurality of RAN radio resource sharing requests; and
comprising:
controlling distribution of communication signals by being configured to control distribution of the downlink communication signals from the plurality of RANs to the plurality of RUs at the downlink frequency within the downlink bandwidth allocated for each of at least one frequency bands for each of the plurality of RANs in the radio resource information in the radio resource configuration.

16. The method of claim 13, wherein:
the plurality of RAN radio resource sharing requests each further comprise an uplink frequency for each of the at least one requested frequency bands of the plurality of supported frequency bands; and
further comprising:
configuring the radio resource information in the radio resource configuration with the uplink frequency for each of at least one frequency bands requested to be supported for each of the plurality of RANs in the plurality of RAN radio resource sharing requests; and
comprising:
control distribution of communication signals by being configured to control distribution of uplink communication signals from the plurality of RUs to the plurality of RANs at the uplink frequency allocated for each of at least one frequency bands for each of the plurality of RANs in the radio resource information in the radio resource configuration.

17. The method of claim 16, wherein:
the plurality of RAN radio resource sharing requests each further comprises an uplink bandwidth for each uplink frequency of the at least one requested frequency bands of the plurality of supported frequency bands; and
further comprising:
configuring the radio resource information in the radio resource configuration with the uplink bandwidth for each uplink frequency of the at least one frequency band requested to be supported for each of the plurality of RANs in the plurality of RAN radio resource sharing requests; and
comprising:
controlling distribution of communication signals by being configured to control distribution of the uplink communication signals from the plurality of RUs to the plurality of RANs at the uplink frequency within the uplink bandwidth allocated for each of at least one frequency bands for each of the plurality of RANs in the radio resource information in the radio resource configuration.

18. The method of claim 13, wherein:
the plurality of RAN radio resource sharing requests each further comprises power sharing information between the at least one requested frequency band of the plurality of supported frequency bands; and
further comprising:
configuring the radio resource information in the radio resource configuration with the power sharing information indicating power share for each of the least one frequency bands requested to be supported for each of the plurality of RANs in the plurality of RAN radio resource sharing requests; and
comprising:
controlling distribution of communication signals by being configured to control power sharing for the communication signals distributed between the plurality of RANs and the plurality of RUs based on the power sharing information for each of the at least one frequency bands allocated for each of the plurality of RANs in the radio resource information in the radio resource configuration.

19. The method of claim 12, wherein:
the shared radio resources comprise a plurality of radio signal inputs each configured to be coupled to a RAN of the plurality of RANs, wherein each of the radio signal inputs is configured to carry a communication signal of the communication signals;
the plurality of RAN radio resource sharing requests each comprise at least one requested radio signal input of the plurality of radio signal inputs; and
comprising:
configuring the radio resource information in the radio resource configuration with the at least one radio signal input requested to be supported for each of the plurality of RANs in the plurality of RAN radio resource sharing requests; and
controlling distribution of the communication signals between the plurality of RANs and the plurality of RUs over the at least one radio signal input allocated for each of the plurality of RANs in the radio resource information in the radio resource configuration.

20. The method of claim 19, wherein the plurality of radio signal inputs comprises a plurality of baseband signal inputs, wherein:
the shared radio resources comprise a plurality of baseband signal inputs each configured to be coupled to a RAN of the plurality of RANs, wherein each of the radio signal inputs is configured to carry a baseband communication signal of the communication signals;
the plurality of RAN radio resource sharing requests each comprise at least one requested baseband signal input of the plurality of baseband signal inputs; and
comprising:
configuring the radio resource information in the radio resource configuration with the at least one baseband signal input requested to be supported for each of the plurality of RANs in the plurality of RAN radio resource sharing requests; and
controlling distribution of the communication signals between the plurality of RANs and the plurality of RUs over the at least one baseband signal input allocated for each of the plurality of RANs in the radio resource information in the radio resource configuration.

21. The method of claim 19, wherein the plurality of radio signal inputs comprises a plurality of radio-frequency (RF) signal inputs, wherein:
the shared radio resources comprise a plurality of RF signal inputs each configured to be coupled to a RAN of the plurality of RANs, wherein each of the radio signal inputs is configured to carry an RF communication signal of the communication signals;
the plurality of RAN radio resource sharing requests each comprise at least one requested RF signal input of the plurality of RF signal inputs; and
comprising:
configuring the radio resource information in the radio resource configuration with the at least one RF signal input requested to be supported for each of the plurality of RANs in the plurality of RAN radio resource sharing requests; and
controlling distribution of the communication signals between the plurality of RANs and the plurality of RUs over the at least one RF signal input allocated for each of the plurality of RANs in the radio resource information in the radio resource configuration.

22. The method of claim 12, wherein:
the radio resources comprise a plurality of antenna ports each configured to be coupled to a RU of the plurality of RUs, wherein each of the antenna ports is configured to carry a communication signal of the communication signals;
the plurality of RAN radio resource sharing requests each comprise at least one requested antenna port of the plurality of antenna ports; and comprising:
configuring the radio resource information in the radio resource configuration with the at least one antenna port requested to be supported for each of the plurality of RANs in the plurality of RAN radio resource sharing requests; and
controlling distribution of the communication signals between the plurality of RANs and the plurality of RUs over the at least one antenna port allocated for each of the plurality of RANs in the radio resource information in the radio resource configuration.

23. A multiple (multi-) operator radio access network (RAN) system, comprising: a plurality of radio access networks (RANs);
a plurality of remote units (RUs); and
a radio infrastructure configured to be communicatively coupled to a plurality of remote units (RUs) and a plurality of radio access networks (RANs), the radio infrastructure comprising:
shared radio resources configured to be utilized to distribute communication signals; and
a controller configured to:
control distribution of communication signals between the plurality of RANs and the plurality of RUs based on radio resource information in a radio resource configuration indicating an allocation of shared radio resources to each of the plurality of RANs;
receive a plurality of RAN radio resource sharing requests each comprising RAN shared resource information for each of the plurality of RANs; and
configure the radio resource information in the radio resource configuration based on the RAN shared resource information in the plurality of RAN radio resource sharing requests to allocate the shared radio resources to the plurality of RANs.
